(19) United States
(12) Patent Application Publication
(10) Pub. No.: US 2026/0027793 A1
(43) Pub. Date: Jan. 29, 2026

(54) TIRE CURING USING A FULLY INTEGRATED HYBRID ELECTROMAGNETIC INDUCTION-NITROGEN HEATING SYSTEM

(71) Applicant: AMERICAN ENGINEERING GROUP LLC, Akron, OH (US)

(72) Inventors: Abraham Pannikottu, Akron, OH (US); Jon Gerhardt, Stow, OH (US)

(21) Appl. No.: 18/993,380

(22) PCT Filed: Jul. 11, 2023
(86) PCT No.: PCT/US23/69960

§ 371 Date: Jan. 10, 2025

Related U.S. Application Data
(60) Provisional application No. 63/388,009, filed on Jul. 11, 2022.

(51) Int. Cl. B29D 30/06; H05B 6/06; H05B 6/10; H05B 6/44

(52) U.S. Cl. CPC B29D 30/0662; B29D 30/0654; H05B 6/06; H05B 6/105; H05B 6/44; B29D 2030/067; B29D 2030/0674; B29D 2030/0675; H05B 2213/07

(57) ABSTRACT

A waterless tire curing system for curing a tire in a mold includes a platen and a mold jacket configured to have at least one component of the mold coupled thereto. The platen and the mold jacket include an induction coil. An electric coil is provided that produces an electromagnetic field to induce an eddy current into the induction coil to produce a first heat energy. A bladder is disposed in an interior of the mold and a nitrogen supply system is included to provide a heated pressurized nitrogen gas for circulation through the bladder. The heat energy from the induction coil is transferred to the mold and the uncured tire. The heat energy from the heated pressurized nitrogen gas is transferred to the bladder and the uncured tire, wherein the heat energy transferred to the uncured tire is effective to cure the tire.

### CROSS-REFERENCE TO RELATED APPLICATIONS

This application claims the benefit of U.S. Provisional Application No. 63/388,099, filed on Jul. 11, 2022. The entire disclosure of the above application is hereby incorporated herein by reference.

### FIELD

The present disclosure relates to curing tires, and more particularly to the use of electromagnetic induction and nitrogen for curing tires.

### INTRODUCTION

This section provides background information related to the present disclosure which is not necessarily prior art.

Tires have been vulcanized or cured in a press wherein pressurized steam is utilized to supply heat energy to a green (un-vulcanized or uncured) tire. The heat energy can be applied to an outer or external surface of the green tire by circulating the pressurized steam through a set of platens cooperating with a tire mold coupled thereto. The heat energy can be applied to an inner surface of the green tire by circulating the pressurized steam through a curing bladder that is in contact with an inner surface of the green tire. The heat energy is applied to the green tire from both the outer surface and the inner surface of the tire for a certain length of time to effect vulcanization of the green tire and produce the vulcanized or cured tire in the form of the tire mold.

Tire curing presses that utilize pressurized steam with platens, bladders, and tire molds are well known in the art. The tire curing presses generally employ separable mold halves or sidewall rings with segmented mold portions and utilize the pressurized steam and the bladder to force the outer surface of the green tire into the tire mold. The curing presses typically are controlled by a mechanical timer or a programmable logic controller (PLC) which cycles the presses through various steps during which the tire is shaped, heated, and in some processes cooled prior to unloading from the press. During the curing process, the tire is subjected to high pressure and high temperature for a preset period of time, which is set to provide sufficient cure for all parts of the tire. The cure process can continue to completion outside the press as the tire cools to room temperature.

Traditionally, the heat and pressure needed for tire curing is often added to the process in the form of steam. This traditional tire procedure, however, has a number of disadvantages such as, for example, steam energy has a high cost and the steam itself can be difficult to contain and deliver to a tire curing press through piping systems. The maintenance effort for the steam production and delivery of the steam to the mold and curing press may also lead to long downtimes. Furthermore, not all process parameters for steam application can be adjusted independently from one another. Additional it is typically required to add antioxidants to the steam to protect the bladder from steam induced premature deterioration of the bladder. Moreover, condensing steam can lead to local overheating at the tire and have a negative effect on tire performance.

Tire engineers are faced with the problem of predicting the time period within which each major component of the tire will be satisfactorily cured and, once such a time period is established, the green tire is heated for that period. Typically, the time period that is established to cure the tire is controlled by the last to cure area of the tire; however, this will also result in other areas of the tire continuing to be subject to the heat energy after they have been satisfactorily cured. This results in sub-optimization of production time and waste of heat energy and pressurized steam. The current industry curing process consumes large amounts of steam or superheated water and not all of the heat energy from the steam is absorbed by the green tire because a significant portion is lost to the atmosphere through, for example, the piping of the steam from a boiler to the tire curing press.

Additionally, the manufacture of tires can be in locations where the availability of water is limited or where it may be desired to prioritize the use of water for other purposes, such as for use and/or consumption by humans and animals or for agricultural purposes, for example. Furthermore, efforts to conserve water in general provide tire manufacturers an opportunity to be a contributor to water conservation efforts.

Various designs for curing presses and various curing methods have been proposed to provide a more uniform cure and efficient transfer of heat energy to a green tire, and to minimize the amount of steam or superheated water required to cure the green tire. Some methods use differing materials for mold construction; insulating materials around molds, platens, and steam piping; differing compositions for parts of the tire; and methods for directing more heat energy to the last to cure area of the tire. However, none of the above methods and apparatus have proven entirely satisfactory, and simply establishing the overall cure time control and utilizing steam or superheated water remains the typical method of curing many tires, especially larger tires, such as military tires, truck tires, off-the-road tires, farm tires, aircraft tires, and earthmover tires. Thus, the tire industry is faced with an issue of minimizing the time, heat energy, and water required to satisfactorily cure a green tire.

There is a continuing need for an apparatus, system, and method for efficiently curing tires without the use of water.

### SUMMARY

In concordance with the instant disclosure, an apparatus, system, and method for efficiently curing tires without the use of water has surprisingly been discovered.

The present technology includes articles of manufacture, systems, and processes that relate to vulcanizing or curing green tires.

In one embodiment, a waterless tire curing system for curing a tire in a mold utilizing a bladder disposed in an interior of the mold is disclosed. The tire curing system includes a mold platen including a first induction coil, the first induction coil configured to produce a first electromagnetic field to induce a first eddy current in the mold platen and a mold jacket including a second induction coil, the second induction coil configured to produce a second electromagnetic field to induce a second eddy current in the mold jacket. A nitrogen supply system is provided that is configured to provide a heated pressurized nitrogen gas and circulate the heated pressurized nitrogen gas through the bladder to expand the bladder and force the tire into contact with an interior surface of the mold. A first heat energy generated by the first eddy current induced in the mold platen is transferred to the mold and the tire. A second heat energy generated by the second eddy current induced in the mold jacket is transferred to the mold and the tire. A third heat energy from the heated pressurized nitrogen gas is transferred to the bladder and the tire. The first heat energy, the second heat energy, and the third heat energy is effective to cure the tire.

In another embodiment, a tire curing system for curing a tire in a mold utilizing a bladder disposed in an interior of the mold is disclosed. The tire curing system includes a mold platen including a first induction coil, the first induction coil configured to produce a first electromagnetic field to induce a first eddy current in the mold platen and a mold jacket including a second induction coil, the second induction coil configured to produce a second electromagnetic field to induce a second eddy current in the mold jacket. The tire curing system also includes a nitrogen supply system configured to provide a heated pressurized nitrogen gas and circulate the heated pressurized nitrogen gas through the bladder to expand the bladder and force the tire into contact with an interior surface of the mold. A first heat energy generated by the first eddy current induced in the mold platen is transferred to the mold and the tire. A second heat energy generated by the second eddy current induced in the mold jacket is transferred to the mold and the tire. A third heat energy from the heated pressurized nitrogen gas is transferred to the bladder and the tire. The first heat energy, the second heat energy, and the third heat energy effective to cure the tire. The tire curing system also includes a control system configured to monitor and control a temperature of the mold by control of the first electromagnetic field generated by the first induction coil and the second electromagnetic field generated by the second induction coil. The control system is also configured to monitor and control a temperature, a pressure, and a flow rate of the heated pressurized nitrogen gas circulated through the bladder by control of the nitrogen supply system.

In yet another embodiment, a method of curing a tire in a mold utilizing a bladder disposed in an interior of the mold is provided. The method includes providing a tire curing system having a mold platen including a first induction coil, the first induction coil configured to produce a first electromagnetic field to induce a first eddy current in the mold platen and a mold jacket including a second induction coil, the second induction coil configured to produce a second electromagnetic field to induce a second eddy current in the mold jacket. The tire curing system includes a nitrogen supply system configured to provide a heated pressurized nitrogen gas for circulation through the bladder to expand the bladder and force the tire into contact with an interior surface of the mold. A first heat energy generated by the first eddy current induced in the mold platen is transferred to the mold and the tire. A second heat energy generated by the second eddy current induced in the mold jacket is transferred to the mold and the tire. A third heat energy from the heated pressurized nitrogen gas is transferred to the bladder and the tire.

The first heat energy, the second heat energy, and the third heat energy are effective to cure the tire. The tire curing system also includes a control system configured to monitor and control a temperature of the mold by control of the first electromagnetic field generated by the first induction coil and the second electromagnetic field generated by the second induction coil. The control system is also configured to monitor and control a temperature, a pressure, and a flow rate of the heated pressurized nitrogen gas circulated through the bladder by control of the nitrogen supply system. The method can also include energizing the first induction coil to produce the first electromagnetic field to induce the first eddy current in the mold platen and generate the first heat energy and energizing the second induction coil to produce the second electromagnetic field to induce the second eddy current in the mold jacket and generate the second heat energy. The method can also include heating the mold to a desired temperature utilizing the first heat energy and the second heat energy, placing an uncured tire into an interior of the mold, and causing the heated pressurized nitrogen gas to flow into the bladder to force an outer surface of the uncured tire into contact with an interior surface of the mold. The method can include the steps of monitoring the temperature of at least one of the first induction coil, the second induction coil, the mold platen, the mold jacket, the mold, the tire, and the heated pressurized nitrogen gas; adjusting the temperature of at least one of the first induction coil, the second induction coil, the mold platen, the mold jacket, and the mold by adjusting one of the first electromagnetic field produced by the first induction coil and the second electromagnetic field produced by the second induction coil; and adjusting the temperature of the heated pressurized nitrogen gas circulating through the bladder by operation of the nitrogen supply system. Steps of the method can include monitoring the pressure of the heated pressurized nitrogen gas circulating through the bladder and adjusting the pressure of the heated pressurized nitrogen gas circulating through the bladder by operation of the nitrogen supply system as well as monitoring the flow rate of the heated pressurized nitrogen gas circulating through the bladder and adjusting the flow rate of the heated pressurized nitrogen gas circulating through the bladder by operation of the nitrogen supply system. Steps for the method can also include holding the tire in the mold for a desired period of time to cure the uncured tire to produce the tire and removing the tire from the mold.

In the process of curing a tire, particularly a non-uniform tire such as a tire or a tread for a tire, the challenge is to provide a curing method that provides a sufficient amount of heat energy to the cure-limiting part(s) of the tire to effect substantial cure of said part(s) without over curing other parts of the green tire, and to do so in a productive, time-efficient manner.

The method of the invention uses one or more induction coils made of high thermal diffusivity materials imbedded and/or coupled to a set of platens and a mold ring jacket to reduce the time required to cure or vulcanize a tire where reductions in cure time of 20% or more can be achieved.

The induction coils can be generally tubular shaped and made from high thermal diffusivity materials. The thermal diffusivity value of the material is defined as “thermal conductivity÷(density×specific heat)”. The thermal diffusivity value of the material of the coils is 4×10⁻⁵ m²/s (meters squared per second) or higher. Examples of materials having high thermal diffusivity values are silver, gold, copper, magnesium, aluminum, tungsten, molybdenum, beryllium, and zinc. Alloys of these metals can also be used as long as the thermal diffusivity value of the alloy is 4×10˜5 m²/s or higher.

Since the induction coils can be imbedded inside a set of the platens and/or the mold ring jacket and are subject to high pressure, heat and moisture, the induction coils must be selected to not react with materials used an insulation or in the platens and/or the mold ring jacket, especially during the cure process. This means that the material of the induction coils should (a) be compatible with the material of the platens and/or the mold ring jacket and not cause oxidative or galvanic corrosion at the interface of the induction coils and the insulation of the platens and/or the mold ring jacket, and (b) not be reactive with the rubber and its ingredients and other components of the tire, especially in a hot, moist environment as can exist in the tire platens and/or the mold ring jacket. Hence, in some situations, high thermal diffusivity materials such as substantially pure copper, magnesium and zinc may not be the best choices as materials for coils as these materials may be reactive with the insulation and the platens and/or the mold ring jacket.

Also, in some situations, high thermal diffusivity materials such as silver, gold, magnesium, molybdenum, and beryllium may not be the best choices as materials for the induction coil as these materials may not withstand the molding and demolding pressures due to low yield strength or brittleness of the high thermal diffusivity material. However, low yield strength or brittle high thermal diffusivity materials can be used for the as coils if the material is fully encased or encased on its sides in an insulation of high yield strength, mechanically resilient material such as steel. The insulation supports the high thermal diffusivity material core and enables it to withstand the molding and de-molding forces.

Further, regardless of the chemical and mechanical properties of the high thermal diffusivity material, encasing the high thermal diffusivity material in a sheathing of a material having low thermal diffusivity, i.e., less than 7×10˜6 m²/s, can be advantageous. For example, an induction coil can include a tubular core made out of a high thermal diffusivity material such as an aluminum alloy and encased on its sides with a high yield strength, low thermal diffusivity material such as stainless steel. In certain embodiments, the inductive coil can be sheathed or insulated on its sides. The sheathing mitigates against damage to the induction coils in the press, and also directs the heat energy from the induction coils toward the unsheathed portions thereof.

The inductive coil that has a tubular core made of a high thermal diffusivity material encased by a sheath can be made by drilling a hole in the material used as the sheath and filling the hole with the high thermal diffusivity material. Also, the high thermal diffusivity core can be machined or otherwise formed and then pressed into tubes of the sheathing material to form the inductive coils. Further, the inductive coils can be made by coating the high thermal diffusivity material core with the sheath material by electroplating or other means.

Because of the concerns with reactive ingredients in the tire and the mechanical forces in the mold, the more preferred high thermal diffusivity materials are tungsten and aluminum alloys. The more preferred sheathing material is stainless steel, due to its combination of high yield strength, non-reactivity, and low thermal diffusivity.

One or more of the high thermal diffusivity induction coils can be added to a mold, the platen, and mold jacket in known ways such as by welding the induction coils(s) to the inside surface of the platens and/or the mold ring jacket, and by drilling holes into and/or through the mold and inserting the induction coils(s) into the drilled hole.

The induction coils can have any tubular cross-sectional shape, such as round, square, triangular, hexagonal, octagonal, rectangular, or elliptical.

The induction coils can be independently heated. Independent heating of the induction coils(s) can further reduce the cure time in the mold. A practical way to independently heat the coils involves the use of electrical resistance. The heating of the coils can continue during the cure of the green tire. The coils can be independently heated to a temperature of up to about 110% of the target mold temperature chosen for the cure. For example, the induction coils can be heated to about 110° C. to about 170° C., depending on the specified cure temperature for the tire.

In determining a curing time for a tire, an analysis can be made of the rate of heat transfer occurring in all parts of the green tire. However, even knowing this, the total cure time to cure the green tire is traditionally dictated by the time it takes to cure the “cure-limiting” part(s) or “last-to-cure” or “longest time to cure” part(s) of the tire. Hence, using traditional methods, the total cure time period in the mold is set to cure the cure-limiting parts, which results in longer cure times and inefficient use of the curing apparatus. Also, one must be careful to not over-cure other parts of the green tire which could result in loss of performance of the green tire at these over-cured parts.

One objective in tire manufacturing is to reduce the time the tire is in the curing while maintaining a desired performance and/or function of the tire. Accordingly, the induction coils can be placed at selected locations in the mold, the platen, and/or the mold jacket and/or independently heated to provide heat energy adjacent to the cure-limiting part(s) of the tire to reduce the total cure time while minimizing the application of heat energy to the non-cure-limiting part(s) of the tire.

The typical requirement with respect to the nitrogen is to heat the nitrogen gas from an initial or system inlet temperature of about 10° C. (50° F.) to a final or outlet temperature of the nitrogen gas into the bladder of about 210° C. +2.5° C. (410° F. +5° F.), an increase of about 200° C. (360° F.). Additionally, an operating pressure of the nitrogen gas of about 425 PSIG and maximum flow rate of about 30 cfm are desired. In one embodiment, the heaters are fabricated from heavy gauge stainless steel and engineered to be tough, durable units that can endure years of heavy factory use.

A nitrogen gas circulation system can be provided to facilitate heating the nitrogen gas to a desired temperature. The nitrogen gas circulation system can include two heaters piped in series where a first heater is a primary heater and a secondary heater is configured to bring the nitrogen gas to a target curing temperature for circulating in the bladder. Each heater can be insulated where, for example, six inches of high temperature insulation can be provided for each heater.

As compared to steam, utilizing heated nitrogen to apply heat energy and pressure to the inside surface of the green tire facilitates maintaining the desired fluid temperature and pressures in the bladder. Furthermore, utilizing nitrogen enables the curing temperature to be selected independently from the curing pressure.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a tire curing system according to an embodiment of the disclosure;

FIG. 2 is a partially exploded perspective sectional view of an induction heating system of a mold of the tire curing system of FIG. 1;

FIG. 3 is a perspective sectional view of the induction heating system of a mold shown in FIG. 2;

FIG. 4 is a schematic illustration of an embodiment of a nitrogen supply system of the tire curing system of FIG. 1

FIG. 5 is a schematic illustration of another embodiment of the nitrogen supply system of the tire curing system of FIG. 1

FIGS. 6A, 6B, and 6C show flow diagrams illustrating methods of curing a tire utilizing the tire curing system of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves equipment and processes for curing tires.

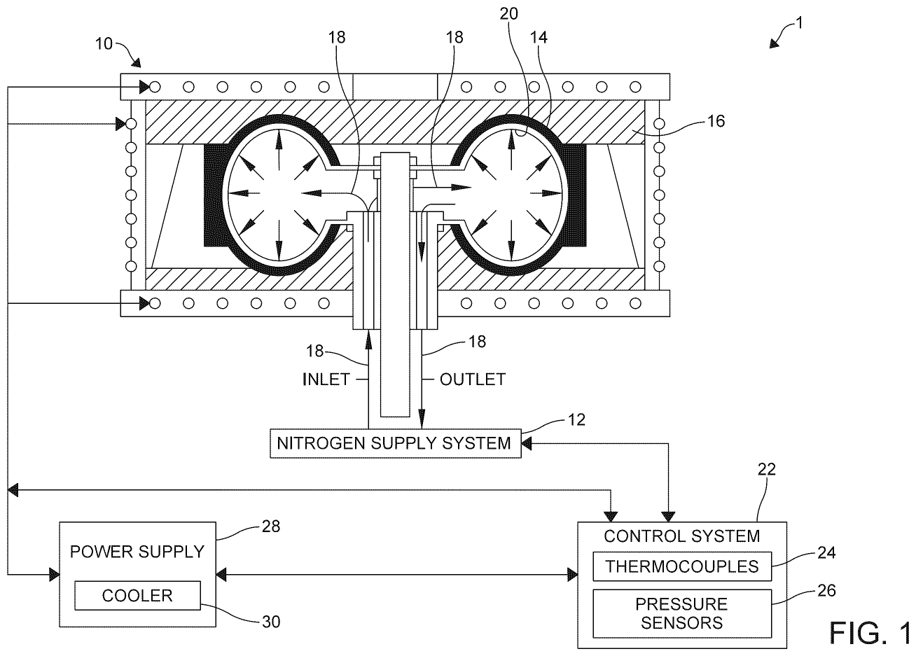

With reference now to FIG. 1, the present technology is drawn to a tire curing system 1 including an induction heating system 10 and a nitrogen supply system 12 for curing a tire 14 in a mold 16. The induction heating system 10 and the nitrogen supply system 12 are configured to supply heat energy to the tire 14 to activate a vulcanization of the uncured rubber in the tire 14 and cure the tire 14. The induction heating system 10 provides heat energy to an exterior surface of the tire 14 through the mold 16. The nitrogen supply system 12 utilizes nitrogen 18 in the form of N₂ gas to provide heat energy to an interior surface of the tire 14 through a bladder 20 disposed in the interior of the mold 16. Favorable results can be obtained by using high-purity N₂ to minimize oxygen content in the bladder 20, which can extend the service life of the bladder 20 and lower the cost of curing the tire 14.

The induction heating system 10 and the nitrogen supply system 12 does not utilize any steam and/or water as a medium for providing heat energy to the tire 14. In other words, the tire curing system 1 of the present disclosure is effective in curing the tire entirely without the use of water in any form.

Accordingly, the tire curing system 1 provides a hybrid induction-nitrogen curing process that is particularly effective for curing tires that do not include metal and electrically conductive components such as steel belts and beads, for example. Such tires are sometimes configured to be run-flat or extended mobility tires where steel belts and bead wire are replaced with composite materials such as carbon fiber and/or aramid, for example. Carbon fiber and/or aramid will not be subject to direct induction heating from the induction heating system 10 and will instead be heated by heat transfer from the mold 16 and the bladder 20.

A control system 22 is provided that is in communication with the induction heating system 10 and the nitrogen supply system 12. The control system 22 is configured to monitor and control a generation of the heat energy produced by the induction heating system 10 and the nitrogen supply system 12. Furthermore, the control system 22 includes a plurality of thermocouples 24 configured to provide temperature readings to the control system 22. The temperature readings can be of various components of the induction heating system 10 and the nitrogen supply system 12, the tire 14, the mold 16, including the nitrogen 18, and the bladder 20. The control system 22 can utilize the temperature readings to adjust the generation of heat energy by the induction heating system 10 and the nitrogen supply system 12. Additionally, the control system 22 can include a plurality of pressure sensors 26 configured to provide fluid pressure readings to the control system 22. The pressure readings can be the pressure of the nitrogen 18 at various locations within the nitrogen supply system 12, including the pressure of the nitrogen 18 within the bladder 20. The control system 22 can utilize the pressure readings to adjust the pressure of the nitrogen 18 within the nitrogen supply system 12, including the pressure of the nitrogen 18 within the bladder 20.

The control system 22 can also include a programmable controller, a computer, a processor, a memory, and combinations thereof. The computer may be an industrial computer. Advantageously, the industrial computer is more durable than generic computers. The memory may be in communication with the processor. The memory may include a tangible, non-transitory computer readable memory with processor-executable instructions stored thereon. The processor-executable instructions may be utilized by the control system 22 to carry out the desired operations and functions of the induction heating system 10 and the nitrogen supply system 12. For example, a curing process or recipe for a particular tire can be stored in the memory of the control system 22 where the control system can cause the steps of the curing process to be carried out to cure the tire 14. It should also be understood that the induction heating system 10, the nitrogen supply system 12, the mold 16, and the bladder 20 are all configured to be installed in and/or cooperate with a tire curing press as is known in the field. The control system 22 can also be configured to control the function of the tire curing press, such as, for example, the opening and closing of the press, the loading of the tire 14 into the mold, the unloading of the tire 14 from the mold 16, and the conveying of the tire 14 away from the tire curing press.

It should be understood that the control system 22 operates to integrate the function and/or operations of the induction heating system 10 with the nitrogen supply system 12. For example, the control system 22 can monitor current curing conditions such as, for example, temperatures of the tire 14, the bladder 20, the mold 16, and the nitrogen 18, as well as the pressure and flow rates of the nitrogen 18, and then adjust an operation of the induction heating system 10 and/or the nitrogen supply system 12 to optimize the curing process. It should be understood that the optimization of the curing process can include, but is not limited to, minimizing the cure time, minimizing total heat energy utilized, or optimizing the state of cure of rubber components in the tire 14, for example. It should also be understood that the control system 22 can provide alarms, or abort the curing process, upon the detection of certain conditions such as low or high temperatures, pressures, or flow rates. The control system 22 can also include artificial intelligence and/or machine learning based controllers, systems, and algorithms, for example, to provide an adaptive control system. It should be understood that the artificial intelligence capability can be configured to receive and analyze inputs from the induction heating system 10 and the nitrogen supply system 12 including, but not limited to, fluid pressure signals and temperature signals from sensors to optimize the tire curing process and tire curing cycle times as well as predict and modify curing process outcomes.

A power supply 28 can be provided to supply electrical energy to the induction heating system 10 and the nitrogen supply system 12. The power supply 28 can include a cooler 30 to facilitate maintaining a desired operating temperature of the power supply 28. The cooler 30 can include common cooling methods such as water cooling, air cooling, and combinations thereof to facilitate maintaining a desired operating temperature of the power supply 28.

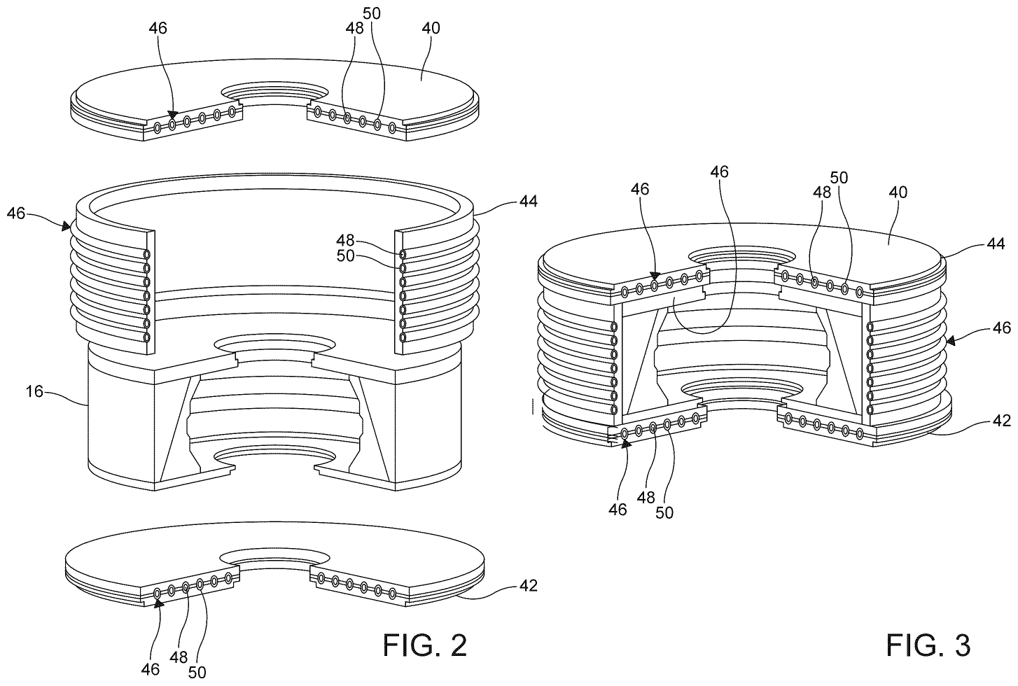

Now referring to FIGS. 2-4, the induction heating system 10 is shown with the mold 16. The induction heating system 10 includes a top platen 40, a bottom platen 42, and a mold jacket 44. The top platen 40, the bottom platen 42, and the mold jacket 44 can be configured to be used with conventional tire curing presses and tire molds as well as be adapted as desired for coupling to and/or being used with tire curing presses and molds. For example, the induction system can be used with two piece molds or segmented molds. The top platen 40, the bottom platen 42, and the mold jacket 44 are configured to be in contact with at least a portion of the outer surface of the mold 16. In certain embodiments, it can be advantageous to maximize contact area between the outer surface of the mold 16 and the top platen 40, the bottom platen 42, and the mold jacket 44 to facilitate the transfer of heat energy therebetween. The top platen 40, the bottom platen 42, and the mold jacket 44 are made from an electrically conducting material, such as an aluminum or a steel, for example.

An induction coil 46 is provided in each of the top platen 40, the bottom platen 42, and the mold jacket 44. The induction coil 46 is in electrical communication with the power supply 28 and configured to use the electrical energy from the power supply 28 to generate a strong electromagnetic field to induce an eddy current into at least one of the top platen 40, the bottom platen 42, and the mold jacket 44. The eddy current is effective to generate heat energy in the top platen 40, the bottom platen 42, and the mold jacket 44 which is transferred to the mold 16 to cure the tire 14. It should be understood that more than one of the induction coils 46 can be used in each of the top platen 40, the bottom platen 42, and the mold jacket 44. As illustrated, each of the top platen 40, the bottom platen 42, and the mold jacket 44 can include a plurality of the induction coils 46. Additionally, each of the induction coils 46 or groups of the induction coils 46 can be controlled independently to facilitate generating the desired amount of heat energy as well as vary the amount of heat energy provided at different locations around the outer exterior surface of the mold 16. The control system 22 is configured to control and/or regulate the flow of electrical energy from the power supply 28 to the induction coils 46 to generate a desired electromagnetic field that results in an eddy current within the top platen 40, the bottom platen 42, and the mold jacket 44 to produce the desired heat energy and/or temperatures required to cure the tire 14. In one example, the induction coils 46 can be energized to provide a temperature in the top platen 40, the bottom platen 42, and the mold jacket 44 of up to about 110% of the desired temperature of the mold 16 cure temperature. As a no limiting example, the top platen 40, the bottom platen 42, and the mold jacket 44 coils can be heated to from about 110 degrees Celsius to about 170 degrees Celsius, depending on the cure temperature and/or the desired temperature of the mold 16 for the tire 14.

In the illustrated embodiment, the induction coils 46 are tubular in shape with a round cross-section. It should be understood that the coils can have any tubular cross-sectional shape, such as, round, square, triangular, hexagonal, octagonal, rectangular, or elliptical. The induction coils 46 can be coupled to a surface of the top platen 40, the bottom platen 42, and the mold jacket 44 in known ways such as by welding or utilizing mechanical fasteners, for example. Additionally, the induction coils 46 can be embedded within the top platen 40, the bottom platen 42, and the mold jacket 44 by drilling holes therein and inserting the induction coils into the holes; by casting the top platen 40, the bottom platen 42, and the mold jacket 44 around the induction coils 46; and by utilizing a 2-piece construction for the top platen 40, the bottom platen 42, and/or the mold jacket 44 where the induction coils 46 are disposed between the 2 pieces. A diameter of the cross-section of the induction coils can be from 1.0 millimeter to about 15millimeters and a cross-sectional area of between about 0.1% and about 1.0% of the total surface area of a tread block or rib in the cure-limiting portion of the tire 14.

In certain embodiments, the induction coils 46 include a core 48 having high thermal diffusivity where the core 48 is encased in a sheath 50. A diameter of the cross-section of the core 48 can be from 1.0 millimeter to about 15 millimeters. The induction coils 46 can be made by drilling a hole in the sheath 50 and filling the hole with the high thermal diffusivity material to form the core 48. Additionally, the core 48 can be machined or otherwise formed and then pressed into the holes formed in the hollow center portion of the sheath 50. Further, the induction coils 46 can be made by coating the core 48 with the sheath 50 by electroplating or other means. The sheath 50 militates against damage to the core 48.

The induction coils 46 can be made from a high thermal diffusivity materials. The thermal diffusivity value of the material is defined as “thermal conductivity÷(density×specific heat)”. In one embodiment, the thermal diffusivity value of the material is about 4.0×10⁻⁵ m²/s (meters squared per second) or higher. Examples of materials having high thermal diffusivity values are silver, gold, copper, magnesium, aluminum, tungsten, molybdenum, beryllium, and zinc. It should be understood that alloys including one or more of these materials can be used provided that the alloy would preferably have a thermal diffusivity value of about 4.0×10⁻⁵ m²/s or higher.

The induction coils 46 may be subject to high pressure, high temperatures, moisture, and other environmental conditions often found in industrial and manufacturing facilities. Accordingly, the materials for the induction coils 46, as well as the core 48 and the sheath 50, can be chosen to suitably withstand the environmental conditions as well as to minimize undesired reactions with adjacent and/or abutting materials, such as an insulation material that may be applied to one or more of the top platen 40, the bottom platen 42, and the mold jacket 44. Accordingly, the material for the induction coils 46, as well as the core 48 and the sheath 50, should be compatible with the materials used for the top platen 40, the bottom platen 42, and the mold jacket 44; not cause oxidative or galvanic corrosion at the interface of the induction coils 46 with an abutting material; and not be reactive with the rubber, and its ingredients, in the tire 14. Accordingly, preferred high thermal diffusivity materials include tungsten alloys and aluminum alloys. Furthermore, in certain applications, high thermal diffusivity materials such as substantially pure copper, magnesium, and zinc may not be the best choices as materials for the induction coils 46.

In some applications, high thermal diffusivity materials such as silver, gold, magnesium, molybdenum, and beryllium may not be practical and/or the best choices for the high thermal diffusivity material as these materials may provide insufficient yield strength or be too brittle to withstand prolonged use properties such as materials for coil and insulation as coils made of these materials may not withstand the molding and demolding pressures due to low yield strength or brittleness of the high thermal diffusivity material. However, low yield strength or brittle high thermal diffusivity materials can be used for the high thermal diffusivity material if fully encased, or at least partially surrounded, in an insulating material, such as the sheath 50. As illustrated in FIGS. 2-4, the high thermal diffusivity material forming the core 48 is encased in the sheath 50, where the sheath 50 is formed of a high yield strength, mechanically resilient material such as steel and supports the high thermal diffusivity material of the core 48 and enables it to withstand the environmental conditions and use in the tire curing press and associated tire curing process.

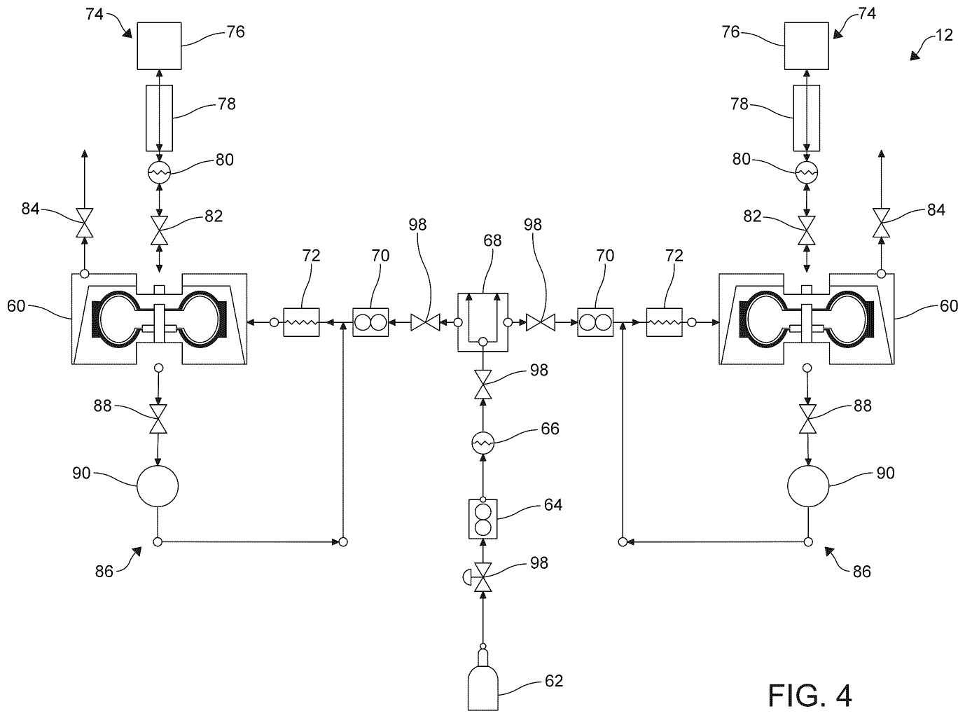

Further, regardless of the chemical and mechanical properties of the high thermal diffusivity material, encasing the high thermal diffusivity material in a sheathing of a material having low thermal diffusivity of about 7.0×10⁻⁶ m²/s or less, can be advantageous. FIGS. 3-4 shows the induction coils 46 with the core 48 made out of a high thermal diffusivity material such as an aluminum alloy, including aluminum 6061, for example, and encased in the sheath 50 of high yield strength, low thermal diffusivity material such as stainless steel, including 316 grade stainless steel for example. Stainless steel is one preferred material for the sheath 50 due to its high yield strength, non-reactivity, and low thermal diffusivity.

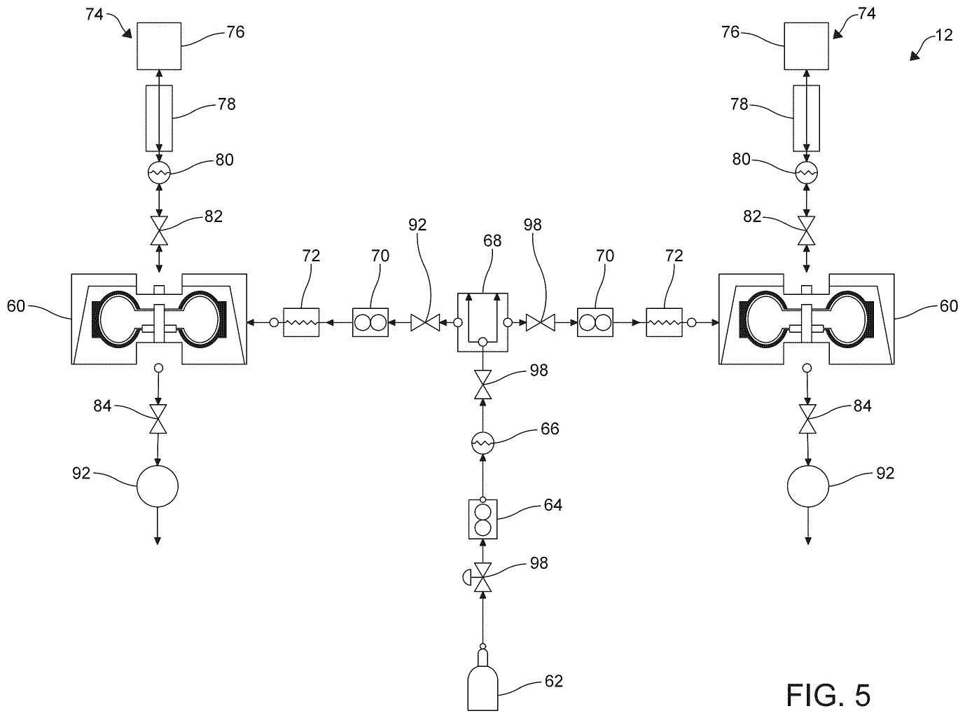

Now referring to FIGS. 4 and 5, schematic representations are shown of two embodiments of the nitrogen supply system 12 with a mold assembly 60 for curing a tire. The nitrogen supply system 12 is configured to provide high temperature and pressure nitrogen gas to the interior of the tire being cured. In the illustrated embodiments, a two cavity configuration is shown where the nitrogen supply system 12 supplies nitrogen to two of the tire mold assemblies. It should be understood that the nitrogen supply system 12 can also be configured to supply nitrogen to one tire mold assembly.

The nitrogen supply system 12 includes a source of nitrogen 62 in fluid communication in series with a first pump or booster 64, a first heater 66, and a flow diverter 68. The first pump 64 is configured to receive nitrogen 18 from the source of nitrogen 62 and direct it to the first heater 66 at a desired pressure and flow rate. The first heater 66 is configured to receive the nitrogen 18 from the first pump 64, heat the nitrogen 18 to a desired temperature, and direct the nitrogen 18 to the flow diverter 68. The flow diverter 68 receives the nitrogen 18 and can then direct the nitrogen 18 now heated toward one or both of the mold assemblies 60 through two separate but substantially identical flow branches of the nitrogen supply system 12. Each of the flow branches includes a second pump or booster 70 and a second heater 72. The second pump 70 is configured to receive nitrogen 18 from the flow diverter 68 and direct it to the second heater 72 at a desired pressure and flow rate. The second heater 72 is configured to receive the nitrogen 18 from the second pump 70, heat the nitrogen 18 to a desired temperature, and direct the nitrogen 18 to the bladder 20 disposed in an interior of the mold assembly 60. Each flow branch can be controlled independently of the other flow branch which allows for different nitrogen pressures and temperatures to be provided to each of the mold assemblies 60.

An auxiliary line 74 can be provided for each mold assembly 60 where the auxiliary line 74 includes a diaphragm pump 76, a regulator 78, an auxiliary heater 80, and an auxiliary valve 82. The auxiliary line 74 is in fluid communication with the interior of the bladder 20. The auxiliary line 74 facilitates the regulation of the pressure and the temperature of the nitrogen 18 in the bladder 20 of the mold assembly 60 where the auxiliary valve 82 can be selectively actuated to be fully closed, fully opened, and at positions therebetween to allow a desired amount of the nitrogen 18 to flow into and out of the auxiliary line 74 where the diaphragm pump 76 and the regulator 78 cooperate to regulate the pressure by allowing a selected flow of nitrogen 18 to and from the bladder 20 of the mold assembly 60. Furthermore, the auxiliary heater 80 can be utilized to heat the nitrogen 18, as desired flowing into and out of the auxiliary line 74.

The nitrogen supply system 12 also includes a plurality of control valves 98 that can selectively actuated to be fully closed, fully opened, and at positions therebetween, to facilitate controlling, as desired, the flow of the nitrogen 18 through the nitrogen supply system 12.

The nitrogen supply system 12 shown in FIG. 4, includes an exhaust valve or exhaust path 84 and a recirculation line 86. The exhaust valve 84 is in fluid communication with the interior of the bladder 20 and configured to selectively release nitrogen 18 therefrom to the atmosphere or an associated exhaust collection system. As shown in FIG. 5, an exhaust pump 92 can be provided with the exhaust valve 84 to facilitate exhausting the nitrogen 18 from the interior of the bladder 20. With renewed reference to FIG. 4, the recirculation line 86 provides fluid communication from the interior of the bladder 20 of the mold assembly 60 to the inlet side of the second heater 72. The recirculation line 86 includes a recirculation valve 88 and a recirculation pump 90. The recirculation valve 88 can be actuated to be fully closed, fully opened, and at positions therebetween to facilitate controlling, as desired, the flow of the nitrogen 18 into the recirculation line 86 and be received by the recirculation pump 90 for pumping to the inlet side of the second heater 72 for recirculation into the interior of the bladder 20.

The nitrogen supply system 12 provides hot pressurized nitrogen to the bladder 20 of the mold assembly 60 to force an outer surface of the uncured tire into contact with the interior surface of the mold 16 in order to give the tire 14 its final shape. The nitrogen 18 can be provided at about 200 psi during this shaping process where the uncured tire is forced into contact with the interior surface of the mold 16 tire.

Upon completion of the shaping process, the pressure of the nitrogen 18 circulating through the bladder 20 can be increased to about 425±5 psi. The temperatures of the nitrogen 18 circulating through the bladder 20 can be about 210° C.±2.5° C. (410±5° F.) or higher with a process control tolerance of about 1%. As the temperature of the nitrogen 18 is increased, there will be no chemical reaction because nitrogen is an inert diatomic gas, being present as N₂ molecules of nitrogen. The flow rate of the nitrogen 18 circulating through the bladder 20 can be in a range of about 5 cfm-50 cfm. In certain embodiments, the nitrogen supply system 12 heats the nitrogen 18 from about 10° C. (50° F.) as provided from the source of nitrogen 62, to a final outlet temperature into the interior of the bladder 20 of 210° C.±2.5°° C. (410° F.±5° F.), an increase of about 200° C. (360° F.). The nitrogen supply system 12 supplies the nitrogen at an operating pressure of about 425 PSIG and a maximum flow rate of about 30 cfm. Use of the nitrogen 18 facilitates optimizing the curing process of the tire 14 as an ideal nitrogen pressure and temperature can be selected independently from each other and be adjusted very quickly, as response time for adjusting the nitrogen pressure and temperature can be about 50 ms. The tire curing system 1 utilizing nitrogen-induction curing processes employs low-pressure nitrogen to inflate the bladder 20 and shape the tire 14 after it is placed in the mold 16. Subsequently, high-pressure nitrogen flows into the bladder 20, and can also be supplied to or around the mold 16, to provide the necessary heat energy for vulcanization. The shaping process can be followed a high-pressure nitrogen stage where high-pressure nitrogen is provided to increase the pressure within the bladder 20 for the remainder of the curing time. At the completion of the cure time, the pressure in the bladder 20 is released, and the tire 14 can be removed from the mold.

It has been found that about 65 KW of electricity are required heat the nitrogen 18 to the desired final outlet temperature. To provide maximum watt densities and keep costs to a minimum related to the heaters 66, 72, and 80, the three heaters 66, 72, and 80 are piped-in series with decreasing kilowatt ratings and watt densities where the first heater 66 has the highest kilowatt rating and watt density, followed by the second heater 72, and then the auxiliary heater 80 with the lowest kilowatt rating and watt density. Additionally, baffles can be used in the heaters 66, 72, and 80 to obtain cross flow, which helps to reduce sheath temperatures, improve heat transfer, and allow for higher watt densities than would be possible in a heater with parallel flow. Furthermore, the heaters 66, 72, and 80 can be insulated to further improve the efficiency thereof. Ina preferred embodiment, six inches of high temperature insulation can be provided to minimize heat loss to the surrounding environment.

It should be understood that the control system 22 is in communication with the components of the induction heating system 10, the nitrogen supply system 12, and the power supply 28. The control system 22 is effective for controlling and coordinating the operation of the induction heating system 10, the nitrogen supply system 12, and the power supply 28, including, but not limited to the control of the induction coils 46, the power supply 28, the heaters 66, 72, 80, the pumps 64, 70, 76, 90, 92, the valves 82, 84, 88, 98, and the regulator 78 all to provide the desired temperature of the mold 16 and the desired temperature, pressure and flow rate of the nitrogen 18 to optimize the curing process and/or minimize the time and energy required to complete the cure process of the tire 14. Additionally, the induction heating system 10 and the nitrogen supply system 12 provide for a hybrid induction-nitrogen cure process for tires that advantageously does not utilize water as a source of heat energy to cure the tire.

A computer model of both the typical steam tire curing process and the hybrid induction-nitrogen (HIN) tire curing process disclosed herein was created and executed to compare the two curing process. The two models used the same tire and only differed by the process variables provided by the two curing processes. As illustrated in Graph 1 below, the results of the simulation show that the increased pressure provided by the HIN curing process resulted in a predicted reduction of time required to complete the cure cycle. Table 1 below shows the reduced cycle time provided by the HIN curing process. Table 1 also shows a cost comparison of the two curing processes based on the shown energy inputs and energy costs.

TABLE 1*
Cost of Steam Curing Versus Hybrid Induction-Nitrogen Curing

| | | | Hybrid | |
|---|---|---|---|---|
| | | | Induction-Nitrogen | |
| Parameter | Steam Curing | | Curing | |
| Total Cycle Time | 750 | seconds | 660 | seconds |
| Bladder Side Energy | 18.75 | lbs/steam | 2.5.00 | KWH |
| input | | | | |
| Mold Side | 16.55 | lbs/steam | 3.00 | KWH |
| Energy Input | | | | |

| Total Energy Input | 35.3 lbs-steam | 5.50 KWH-electricity per tire |
|---|---|---|
| | per tire | |
| Cost: $/lbs steam and | $0.0075 per | $0.040/KWH |
| $/KWH | lbs. | |
| Cost for tire | $0.30 | $0.22 |
| production$/tire | | |

*A boiler fired with natural gas costing $7.00/MMBtu produces 450 psig saturated steam and is supplied with 270° F. feedwater.
Steam Cost: ($7.00/MMBtu/106 Btu/MMBtu) × 1,000 lbs. × 1,006 (Btu/lb.)/0.857 = $7.5/1,000 lbs.)

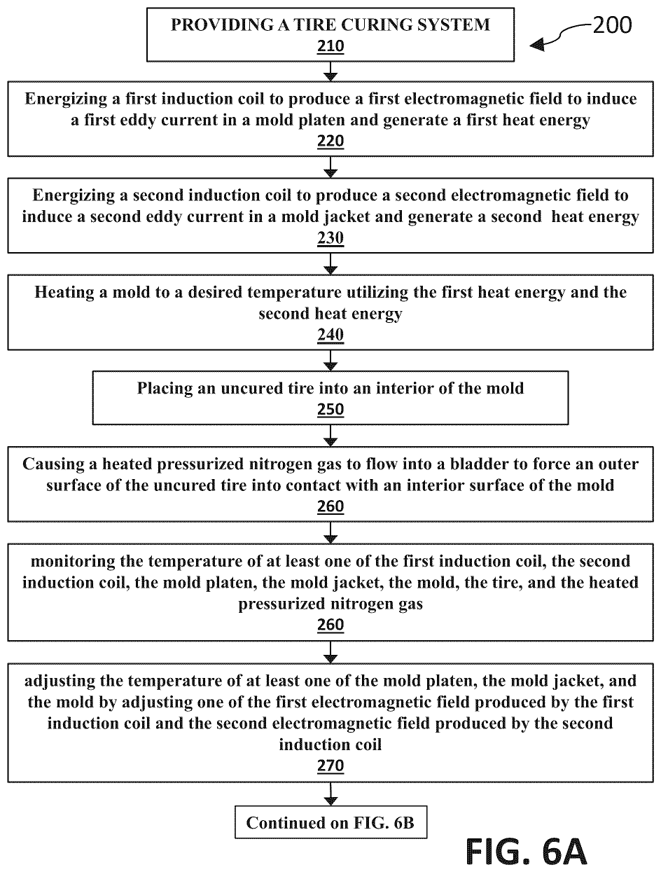

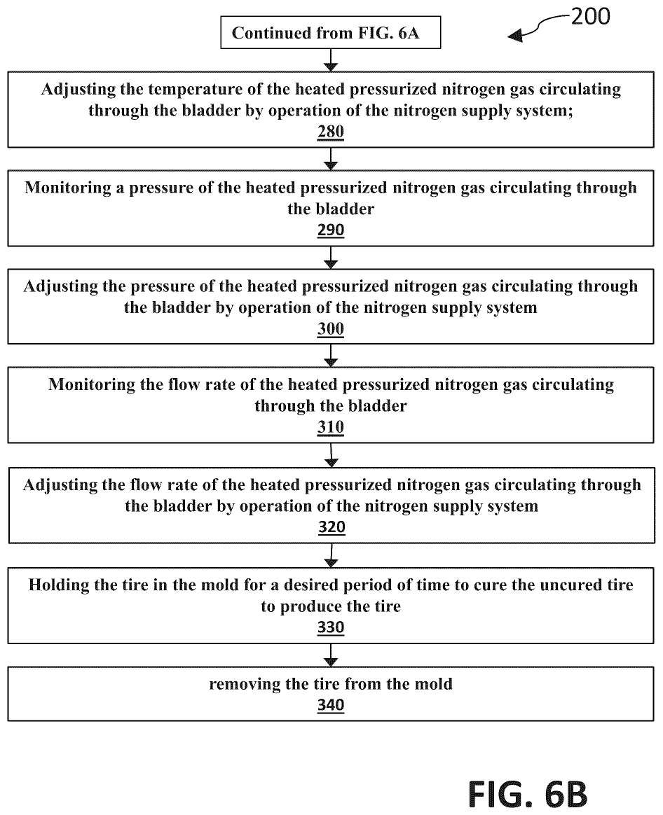

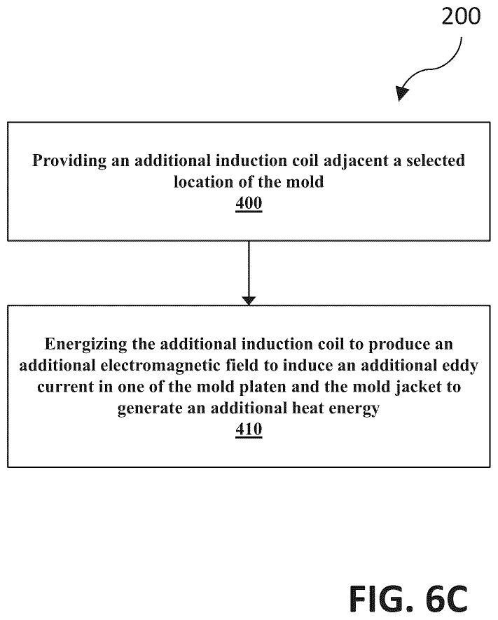

A method 200 for curing a tire in a mold utilizing a bladder disposed in an interior of the mold, is shown in FIGS. 6A-6B. It should be appreciated that the following steps may occur in various consecutive orders with respect to each other, including where certain steps may be performed simultaneously, or with other steps. The method 200 includes step 210 of providing a tire curing system including a mold platen, a mold jacket, a nitrogen supply system, and a control system. The mold platen includes a first induction coil where the first induction coil configured to produce a first electromagnetic field to induce a first eddy current in the mold platen and the mold jacket includes a second induction coil, the second induction coil configured to produce a second electromagnetic field to induce a second eddy current in the mold jacket. The nitrogen supply system can be configured to provide a heated pressurized nitrogen gas for circulation through the bladder to expand the bladder and force the tire into contact with an interior surface of the mold. A first heat energy is generated by the first eddy current induced in the mold platen and is transferred to the mold and the tire. A second heat energy is generated by the second eddy current induced in the mold jacket and is transferred to the mold and the tire. A third heat energy from the heated pressurized nitrogen gas is transferred to the bladder and the tire. The first heat energy, the second heat energy, and the third heat energy effective to cure the tire. The control system of the tire curing system is configured to monitor and control a temperature of the mold by control of the first electromagnetic field generated by the first induction coil and the second electromagnetic field generated by the second induction coil, and to monitor and control a temperature, a pressure, and a flow rate of the heated pressurized nitrogen gas circulated through the bladder by control of the nitrogen supply system.

The method 200 also includes the step 220 of energizing the first induction coil to produce the first electromagnetic field to induce the first eddy current in the mold platen and generate the first heat energy and step 230 of energizing the second induction coil to produce the second electromagnetic field to induce the second eddy current in the mold jacket and generate the second heat energy. In step 240 the mold is heated to a desired temperature utilizing the first heat energy and the second heat energy. An uncured tire is placed in into an interior of the mold in step 250. In step 260, the heated pressurized nitrogen gas is provided to the bladder to inflate the bladder and force an outer surface of the uncured tire into contact with an interior surface of the mold and shape the uncured tire substantially into the shape of the final cured tire.

The control system is utilized to monitor the temperature of at least one of the first induction coil, the second induction coil, the mold platen, the mold jacket, the mold, the tire, and the heated pressurized nitrogen gas in step 270. In step 280, the temperature of at least one of the mold platen, the mold jacket, and the mold can be adjusted by adjusting one of the first electromagnetic field produced by the first induction coil and the second electromagnetic field produced by the second induction coil. In step 290 the temperature of the heated pressurized nitrogen gas circulating through the bladder can be adjusted by operation of the nitrogen supply system. The pressure of the heated pressurized nitrogen gas circulating through the bladder can be monitored in step 300 and in step 310 the pressure of the heated pressurized nitrogen gas circulating through the bladder can be adjusted by operation of the nitrogen supply system. Additionally, in step 320 the flow rate of the heated pressurized nitrogen gas circulating through the bladder can be monitored and in step 320 the flow rate of the heated pressurized nitrogen gas circulating through the bladder can be adjusted by operation of the nitrogen supply system. The tire can be held in the mold for a desired period of time to cure the uncured tire to produce the tire in step 330 the tire can be removed from the mold in step 340.

Additionally, as shown in FIG. 6C, the method 200 can include steps 400 and 410. Step 400 includes providing an additional induction coil at a selected location of one of the mold platen and the mold jacket. Step 410 includes energizing the additional induction coil to produce an additional electromagnetic field to induce an additional eddy current in one of the mold platen and the mold jacket to generate an additional heat energy.

Contrary to conventional trial-and-error tire curing process like high pressure steam or hot water systems, the tire curing system 1 including the induction heating system 10 integrated with the nitrogen supply system 12 can improve the quality of the tire 14 and allow optimization of the curing process. In particular, the tire curing system 1 enables the pressure of the nitrogen 18 to be increased without extreme increase to the temperature of the nitrogen 18 or the overall cure temperature. Furthermore, the tire curing system 1 including the induction heating system 10 integrated with the nitrogen supply system 12 is configured for the nitrogen 18 to prove both heat energy and pressure for the curing process. This integration of the induction heating system 10 with the nitrogen supply system 12 is achieved through the control system 22 and its software and hardware architecture that enables the control system 22 to communicate with and coordinate the operation of the various components and functions of the induction heating system 10 and the nitrogen supply system 12.

The tire curing system 1 including the induction heating system 10 integrated with the nitrogen supply system 12 can be utilized to replace the traditional, trial-and-error steam/hot water tire curing process to provide improved tire production capability that is able to adapt to the varying operating conditions often encountered in the process of curing tires. Furthermore, the induction heating system 10 integrated with the nitrogen supply system 12 can provide lower energy consumption, improved vulcanization energy, and improved tire quality as compared to the traditional, trial-and-error steam/hot water tire curing processes.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A waterless tire curing system for curing a tire in a mold utilizing a bladder disposed in an interior of the mold, the tire curing system comprising:
a mold platen including a first induction coil, the first induction coil configured to produce a first electromagnetic field to induce a first eddy current in the mold platen;
a mold jacket including a second induction coil, the second induction coil configured to produce a second electromagnetic field to induce a second eddy current in the mold jacket; and
a nitrogen supply system configured to provide a heated pressurized nitrogen gas and circulate the heated pressurized nitrogen gas through the bladder to expand the bladder and force the tire into contact with an interior surface of the mold, wherein a first heat energy generated by the first eddy current induced in the mold platen is transferred to the mold and the tire, a second heat energy generated by the second eddy current induced in the mold jacket is transferred to the mold and the tire, and a third heat energy from the heated pressurized nitrogen gas is transferred to the bladder and the tire, the first heat energy, the second heat energy, and the third heat energy effective to cure the tire.

2. The waterless tire curing system of claim 1, wherein the first induction coil and the second induction coil include a material selected from a group consisting of silver, gold, copper, magnesium, aluminum, tungsten, molybdenum, beryllium, and zinc.

3. The waterless tire curing system of claim 1, wherein the first induction coil and the second induction coil are formed from a material having a thermal diffusivity equal to or greater than 4.0×10⁻⁵ m²/s.

4. The waterless tire curing system of claim 1, wherein an insulating material surrounds at least a portion of the first induction coil and the second induction coil.

5. The waterless tire curing system of claim 4, wherein the insulating material has a thermal diffusivity equal to or less than 7.0×10⁻⁶ m²/s.

6. The waterless tire curing system of claim 1, wherein the nitrogen supply system includes a flow path for a nitrogen gas from a source of nitrogen to the bladder, the flow path including two heaters in series configured to heat the nitrogen gas, the two heaters having decreasing kilowatt ratings in a direction of the flow path.

7. The waterless tire curing system of claim 6, wherein the nitrogen supply system includes an auxiliary flow path in fluid communication with the interior of the bladder, the auxiliary flow path including an auxiliary pump and an auxiliary heater configured to facilitate regulating at least one of the third heat energy and a pressure of the nitrogen gas in the bladder.

8. The waterless tire curing system of claim 1, wherein the nitrogen supply system provides the heated pressurized nitrogen gas at about a minimum of 207.5° C., 420 lb/in², and 5 ft³-minute.

9. The waterless tire curing system of claim 1, further comprising a control system, the control system configured to monitor and control a temperature of the mold by control of the first electromagnetic field generated by the first induction coil, by control of the second electromagnetic field generated by the second induction coil, and to monitor and control a temperature, a pressure, and a flow rate the heated pressurized nitrogen gas by control of the nitrogen supply system.

10. The waterless tire curing system of claim 9, wherein the control system includes at least one thermal couple configured to measure the temperature of an object selected from a group consisting of the first induction coil, the second induction coil, the mold platen, the mold jacket, the mold, the bladder, the heated pressurized nitrogen gas, and the tire.

11. A tire curing system for curing a tire in a mold utilizing a bladder disposed in an interior of the mold, the tire curing system comprising:
a mold platen including a first induction coil, the first induction coil configured to produce a first electromagnetic field to induce a first eddy current in the mold platen;
a mold jacket including a second induction coil, the second induction coil configured to produce a second electromagnetic field to induce a second eddy current in the mold jacket;
a nitrogen supply system configured to provide a heated pressurized nitrogen gas and circulate the heated pressurized nitrogen gas through the bladder to expand the bladder and force the tire into contact with an interior surface of the mold, wherein a first heat energy generated by the first eddy current induced in the mold platen is transferred to the mold and the tire, a second heat energy generated by the second eddy current induced in the mold jacket is transferred to the mold and the tire, and a third heat energy from the heated pressurized nitrogen gas is transferred to the bladder and the tire, the first heat energy, the second heat energy, and the third heat energy effective to cure the tire; and
a control system configured to monitor and control a temperature of the mold by control of the first electromagnetic field generated by the first induction coil and the second electromagnetic field generated by the second induction coil, and to monitor and control a temperature, a pressure, and a flow rate of the heated pressurized nitrogen gas circulated through the bladder by control of the nitrogen supply system.

12. The tire curing system of claim 11, wherein the first induction coil and the second induction coil include a material selected from a group consisting of silver, gold, copper, magnesium, aluminum, tungsten, molybdenum, beryllium, and zinc.

13. The tire curing system of claim 11, wherein the first induction coil and the second induction coil are formed from a material having a thermal diffusivity equal to or greater than 4.0×10⁻⁵ m²/s.

14. The tire curing system of claim 11, wherein an insulating material surrounds at least a portion of the first induction coil and the second induction coil.

15. The tire curing system of claim 14, wherein the insulating material has a thermal diffusivity equal to or less than 7.0×10⁻⁶ m²/s.

16. The tire curing system of claim 11, wherein the nitrogen supply system includes a flow path for a nitrogen gas from a source of nitrogen to the bladder, the flow path including two heaters in series configured to heat the nitrogen gas, the two heaters having decreasing kilowatt ratings in a direction of the flow path.

17. The tire curing system of claim 11, wherein the nitrogen supply system provides the heated pressurized nitrogen gas at a minimum of 207.5° C., 425 lb/in², and 5 ft³-minute.

18. The tire curing system of claim 11, wherein the control system includes at least one thermal couple configured to measure the temperature of an object selected from a group consisting of the first induction coil, the second induction coil, the mold platen, the mold jacket, the mold, the bladder, the heated pressurized nitrogen gas, and the tire.

19. A method for curing a tire in a mold utilizing a bladder disposed in an interior of the mold, the method comprising steps of:
providing a tire curing system including;
a mold platen including a first induction coil, the first induction coil configured to produce a first electromagnetic field to induce a first eddy current in the mold platen;
a mold jacket including a second induction coil, the second induction coil configured to produce a second electromagnetic field to induce a second eddy current in the mold jacket;
a nitrogen supply system configured to provide a heated pressurized nitrogen gas for circulation through the bladder to expand the bladder and force the tire into contact with an interior surface of the mold, wherein a first heat energy generated by the first eddy current induced in the mold platen is transferred to the mold and the tire, a second heat energy generated by the second eddy current induced in the mold jacket is transferred to the mold and the tire, and a third heat energy from the heated pressurized nitrogen gas is transferred to the bladder and the tire, the first heat energy, the second heat energy, and the third heat energy effective to cure the tire; and
a control system configured to monitor and control a temperature of the mold by control of the first electromagnetic field generated by the first induction coil and the second electromagnetic field generated by the second induction coil, and to monitor and control a temperature, a pressure, and a flow rate of the heated pressurized nitrogen gas circulated through the bladder by control of the nitrogen supply system; and
performing one of:
energizing the first induction coil to produce the first electromagnetic field to induce the first eddy current in the mold platen and generate the first heat energy;
energizing the second induction coil to produce the second electromagnetic field to induce the second eddy current in the mold jacket and generate the second heat energy;
heating the mold to a desired temperature utilizing the first heat energy and the second heat energy;
placing an uncured tire into an interior of the mold;
causing the heated pressurized nitrogen gas to flow into the bladder to force an outer surface of the uncured tire into contact with an interior surface of the mold;
monitoring the temperature of at least one of the first induction coil, the second induction coil, the mold platen, the mold jacket, the mold, the tire, and the heated pressurized nitrogen gas;
adjusting the temperature of at least one of the mold platen, the mold jacket, and the mold by adjusting one of the first electromagnetic field produced by the first induction coil and the second electromagnetic field produced by the second induction coil;
adjusting the temperature of the heated pressurized nitrogen gas circulating through the bladder by operation of the nitrogen supply system;
monitoring the pressure of the heated pressurized nitrogen gas circulating through the bladder;
adjusting the pressure of the heated pressurized nitrogen gas circulating through the bladder by operation of the nitrogen supply system;
monitoring the flow rate of the heated pressurized nitrogen gas circulating through the bladder;
adjusting the flow rate of the heated pressurized nitrogen gas circulating through the bladder by operation of the nitrogen supply system;
holding the tire in the mold for a desired period of time to cure the uncured tire to produce the tire; and
removing the tire from the mold.

20. The method for curing a tire in a mold of claim 19, further including the steps of:
providing an additional induction coil adjacent a selected location of the mold; and
energizing the additional induction coil to produce an additional electromagnetic field to induce an additional eddy current in one of the mold platen and the mold jacket to generate an additional heat energy.
